(19) United States
(12) Patent Application Publication
(10) Pub. No.: US 2025/0321530 A1
(43) Pub. Date: Oct. 16, 2025

(54) IMAGE FORMING APPARATUS, IMAGE FORMING SYSTEM, AND FRONT-TO-BACK REGISTRATION ADJUSTMENT METHOD AND PROGRAM

(71) Applicant: Konica Minolta, Inc., Tokyo (JP)

(72) Inventor: Takashi YAMASHITA, Tokyo (JP)

(21) Appl. No.: 19/098,422

(22) Filed: Apr. 2, 2025

(30) Foreign Application Priority Data
Apr. 12, 2024 (JP) 2024-064557

(51) Int. Cl. G03G 15/00; H04N 1/00

(52) U.S. Cl. CPC G03G 15/6508; H04N 1/00039; H04N 1/00045; H04N 1/00055; H04N 1/00063; H04N 1/00082; H04N 2201/0094

(57) ABSTRACT

An image forming apparatus in an image forming system including: a first tray that feeds recording media; a second tray that feeds recording media; and a reading section, wherein the image forming apparatus includes: a controller; and an image forming section that forms images on the recording media fed from the first tray and second tray. The reading section is configured to read the images formed on the recording media fed from the first tray and second tray. The controller, while performing a print job on the recording media fed from the first tray: prints, using the image forming section, a front-to-back registration adjustment chart on a recording medium fed from the second tray; reads the printed front-to-back registration adjustment chart using the reading section; and performs a front-to-back registration adjustment for the second tray based on the read front-to-back registration adjustment chart.

### CROSS REFERENCE TO RELATED APPLICATIONS

This application claims foreign priority to Japanese Patent Application No. 2024-064557, filed Apr. 12, 2024, the disclosure of which is incorporated herein by reference in its entirety.

### BACKGROUND

### Technological Field

The present invention relates to an image forming apparatus, an image forming system, a front-to-back registration adjustment method and a front-to-back registration adjustment program.

### Description of Related Art

There is known an image forming apparatus configured to detect an opened/closed state of a tray and, when the image forming apparatus detects the tray having been opened and closed and is to output a job using the tray, perform a front-to-back image registration adjustment before performing the job (see, for example, Japanese Unexamined Patent Publication No. 2018-197788).

FIG. 9 is a process diagram illustrating a sheet feed pattern for when a waste sheet is detected in the conventional example described in Japanese Unexamined Patent Publication No. 2018-197788. According to the image forming method described in Japanese Unexamined Patent Publication No. 2018-197788, as illustrated in FIG. 9, first, the image forming apparatus performs printing (step S1000) on the 1st to n-th pages of the sheets fed from the upper tray. After the printing, if the sheets in the upper tray run out, the image forming apparatus changes (step S1100) the sheet feed source from the upper tray to the lower tray. Next, while the image forming apparatus is printing the sheets in the lower tray, the user opens the upper tray, supplies sheets to the upper tray, and close the upper tray (step S1200).

When the sheets in the lower tray currently used in printing run out, the image forming apparatus switches the sheet feed source from the lower tray to the upper tray (step S1300). Subsequently, when the image forming apparatus detects that the upper tray has been opened and then closed, the image forming apparatus performs (step S1400) a front-to-back registration adjustment for the upper tray. Then, the image forming apparatus feeds (step S1500) sheets from the upper tray to the image forming section.

### SUMMARY

### Problems to be Solved by the Invention

However, in the image forming method described in Japanese Unexamined Patent Publication No. 2018-197788, when the sheet feed source tray is switched from the upper tray to the lower tray or from the lower tray to the upper tray, as the sheet feed source tray has been opened and closed, an image printed on the front side of a sheet and an image printed on the back side of the sheet may be misaligned. Thus, when the front-to-back registration adjustment values obtained by the front-to-back registration adjustment are not applied to the sheets from the first sheet, there is a possibility that the front-to-back registration for the first sheet causes misalignment. For this reason, when the sheet feed source tray is switched from the lower tray to the upper tray, it is important to perform the front-to-back registration adjustment for the upper tray.

As a result, when performing printing by the image forming system in order to perform the front-to-back registration adjustment for a tray, the machine is once stopped, and after the front-to-back registration adjustment for the sheets to be fed from the tray is completed, the printing of the p-th page is restarted. In this regard, as the image forming method described in Japanese Unexamined Patent Publication No. 2018-197788 temporarily pauses the continuous printing and performs the front-to-back registration adjustment for the tray after switching, there is a problem in that productivity is reduced.

That is, in the image forming method described in Japanese Unexamined Patent Publication No. 2018-197788, when the front-to-back registration adjustment is performed, the sheets are fed after the front-to-back registration adjustment values are determined. Therefore, when a front-to-back registration adjustment for a new tray selected in place of the current tray as the sheet feed source has not been performed while printing, the front-to-back registration adjustment for this new tray is performed, and then sheets are fed from the new tray to perform the print job. Therefore, the image forming method described in Japanese Unexamined Patent Publication No. 2018-197788 has a problem in that productivity is reduced.

The present invention has been made in view of the above-described problem, and an object of the present invention is to provide an image forming apparatus, an image forming system, a front-to-back registration adjustment method, and a front-to-back registration adjustment program, without reducing productivity. Means for Solving the Problem

To achieve the abovementioned objects, an aspect of the present invention is an image forming apparatus in an image forming system including: a first tray that feeds first recording media; a second tray that feeds second recording media; and an image reading device, wherein the image forming apparatus includes: a controller; and an image forming section that forms images on the recording media fed from the first tray and the recording media fed from the second tray. The reading section is configured to read the images formed on the recording media fed from the first tray and the recording media fed from the second tray. The controller, while performing a print job on the recording media fed from the first tray: prints, using the image forming section, a front-to-back registration adjustment chart on a recording medium fed from the second tray; reads the printed front-to-back registration adjustment chart using the reading section; and performs a front-to-back registration adjustment for the second tray based on the read front-to-back registration adjustment chart.

### BRIEF DESCRIPTION OF THE DRAWINGS

The advantages and features provided by one or more embodiments of the invention will become more fully understood from the detailed description given hereinbelow and the following drawings which are given by way of illustration only, and thus are not intended as a definition of the limits of the present invention:

FIG. 1 is a schematic diagram illustrating the overall configuration of an image forming system according to an embodiment of the present invention;

FIG. 2 is a block diagram illustrating the image forming system according to the embodiment of the present invention;

FIG. 3 is a process diagram illustrating a front-to-back registration adjustment method according to an embodiment of the present invention;

FIG. 4 is an explanatory diagram illustrating a front-to-back image registration adjustment chart;

FIG. 5 is an explanatory diagram illustrating a periodic front-to-back image registration adjustment chart;

FIG. 6 is a process diagram illustrating periodic front-to-back image registration adjustment, showing a print process in which the front-to-back image registration adjustment is performed without reducing productivity;

FIG. 7 is a schematic diagram which shows an example of a screen of an operation-and-display part of the image forming system according to the embodiment of the present invention;

FIGS. 8A and 8B are a flowchart illustrating the front-to-back registration adjustment method according to the embodiment of the present invention; and

FIG. 9 is a process diagram illustrating a sheet feed pattern when a waste sheet is detected in the conventional example described in Japanese Unexamined Patent Publication No. 2018-197788.

### DETAILED DESCRIPTION OF EMBODIMENTS

Hereinafter, one or more embodiments of the present invention will be described with reference to the drawings. However, the scope of the invention is not limited to the disclosed embodiments.

Next, embodiments of the present invention will be described in detail with reference to the drawings as appropriate. Note that common members are denoted by the same reference signs in the drawings.

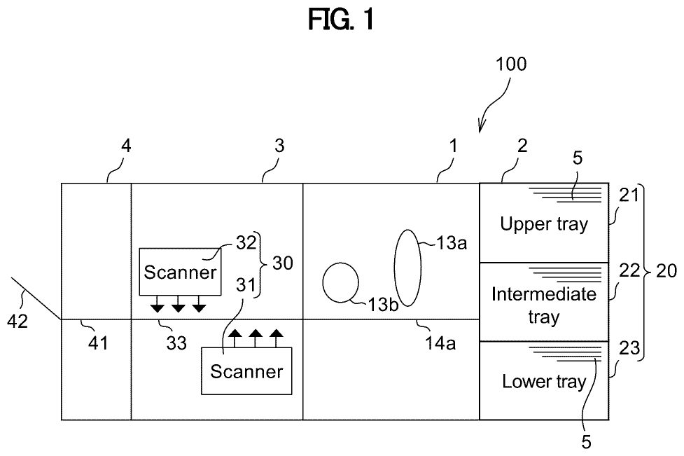

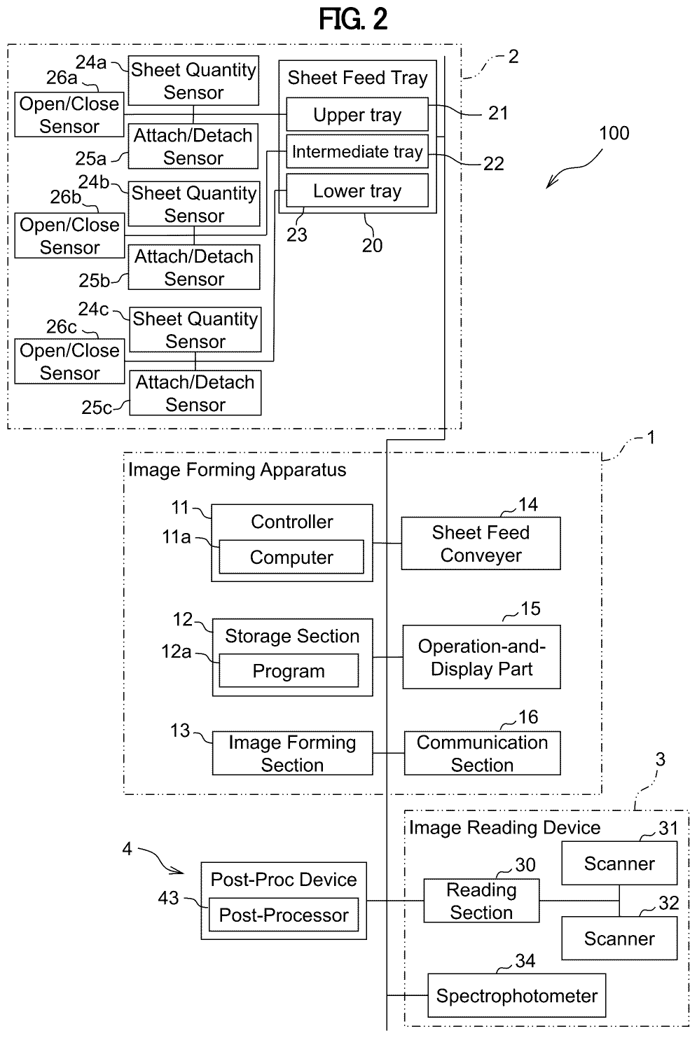

FIG. 1 is a schematic diagram illustrating an overall configuration of an image forming system 100 according to an embodiment of the present invention. FIG. 2 is a block diagram illustrating the image forming system 100 according to the embodiment of the present invention.

### Image Forming System

As illustrated in FIG. 1, the image forming system 100 includes an image forming apparatus 1, a sheet feed device 2, an image reading device 3, and a post-processing device 4.

### Storage Medium

The storage medium used in the image forming system 100 is a recordable and storable medium. Any recording medium may be used as long as an image can be formed on the faces of the recording medium. The recording medium is, for example, a sheet 5, a fabric, a plastic film, a glass plate, or the like. Hereinafter, a case where a sheet 5 is used as the recording medium will be described.

### Image Forming Apparatus

The image forming apparatus 1 is an apparatus that forms an image on a sheet 5. As an example, the image forming apparatus 1 is herein an electrophotographic image forming apparatus for forming a toner image but is not limited thereto, and may be an apparatus of another type such as an inkjet type, for example.

As illustrated in FIG. 2, the image forming apparatus 1 includes a controller 11, a storage section 12, an image forming section 13, a sheet feed conveyer 14, an operation-and-display part 15, and a communication section 16.

### Controller

The controller 11 is a device that performs a front-to-back image registration adjustment based on the result read by the reading section 30 of the image reading device 3. The controller 11, in coordination with the image forming section 13 forming images on the fed sheet 5 and the reading section 30 reading the images formed on the sheet 5, performs a front-to-back image registration adjustment based on the result read by the reading section 30.

When performing image formation on sheets 5 fed from the upper tray 21 and subsequently performing image formation on sheets 5 fed from intermediate tray 22, the controller 11 performs control to: during the image formation on the sheets 5 fed from the upper tray 21, form an image on a sheet 5 fed from the intermediate tray 22 and read the formed image to perform a front-to-back registration adjustment of the images to be formed on the sheets 5 fed from the intermediate tray 22.

When a predetermined condition is satisfied, the controller 11 performs the front-to-back registration adjustment of the images to be formed on the sheet 5 fed from the intermediate tray 22 during the image formation using the sheets 5 stored in the upper tray 21. Examples of the predetermined condition include a condition that, when the intermediate tray 22 is opened, new sheets 5 are set, and then the intermediate tray 22 is closed, the type and/or the size of the newly set sheets 5 is the same as that of the sheets 5 set in the upper tray 21.

The controller 11, when the upper tray 21 runs out of sheets before the front-to-back registration adjustment of the images to be formed on the sheets 5 fed from the intermediate tray 22 is completed, searches for a lower tray 23 having the same condition as the upper tray 21 and the intermediate tray 22. Further, the controller 11 determines whether the front-to-back image registration adjustment has been completed, and switches the tray serving as the sheet feed source.

The controller 11 is constituted by a computer 11a that controls the overall operations of the image forming system 100. Based on the operation performed on the operation-and-display part 15 and based on a reception signal from the image forming system 100 connected to the image forming apparatus 1, the controller 11 controls each part of the image forming apparatus 1 and controls the operation of each part of the sheet feed device 2 and the post-processing device 4. Furthermore, based on image data obtained by the reading section 30, the controller 11 adjusts the color of an image and the position where the image is to be formed. For example, for the adjustment of the image forming position, the controller 11 reads the edge of the sheet 5, a registration mark, a specialized chart, and the like and, based on the positions thereof, adjusts the image forming position.

### Computer

The computer 11a includes a central processing unit (CPU), a read only memory (ROM), a random access memory (RAM), an input/output circuit, and the like. The CPU reads a program 12a pertinent to the processing from the storage section 12 and loads the program into the RAM, controls each constituent part of the image forming system 100 in corporation with the loaded program. At this time, various kinds of data stored in the storage section 12 are referenced.

The computer 11a (controller 11), according to the program 12a, performs procedures of: controlling the sheet feed device 2 to detect opening and closing of the intermediate tray 22 during a print job using sheets 5 fed from the upper tray 21, controlling the image forming section 13 to print a front-to-back registration adjustment chart on a sheet 5 fed from the intermediate tray 22, controlling the reading section 30 of the image reading device 3 to read the formed front-to-back registration adjustment chart, and performing a front-to-back registration adjustment for the intermediate tray 22 based on the read front-to-back registration adjustment chart.

### Storage Section

The storage section 12, illustrated in FIG. 2, is a storage device that stores information related to the image forming system 100, information related to the states of the upper tray 21, the intermediate tray 22, and the lower tray 23 of the sheet feed device 2 that stores the sheets 5, and the like. The storage section 12 stores image data and the like such as a color chart in which color patches of a plurality of colors for various evaluations are arranged, and a front-to-back registration adjustment chart dedicated to adjust front-side and back-side image positions. The storage section 12 includes, for example, a non-volatile semiconductor memory (so-called flash memory) or a hard disk drive.

### Program

The program 12a is a so-called firmware program that causes the computer 11a to execute various procedures to process information. The program 12a causes the computer 11a (controller 11) to perform procedures of: detecting whether the intermediate tray 22 is opened and then closed during a print job using sheets 5 fed from the upper tray 21, printing a front-to-back registration adjustment chart on a sheet 5 fed from the intermediate tray 22 using the image forming section 13, reading the formed front-to-back registration adjustment chart using the reading section 30, and performing a front-to-back registration adjustment for the intermediate tray 22 based on the read front-to-back registration adjustment chart.

### Image Forming Section

The image forming section 13 is a device that, based on instructions and data received from the controller 11, forms images on the sheets 5 fed from the sheet feed device 2. The image forming section 13 forms images on the sheets 5, which are fed from the upper tray 21, intermediate tray 22, and lower tray 23. The image forming section 13 also forms a front-to-back registration adjustment chart based on an instruction and data received from the controller 11. The image forming section 13 forms an image on the sheet 5 fed from the intermediate tray 22 for which a front-to-back image registration adjustment has been performed. The image forming section 13 includes an intermediate transfer belt 13a and a fixing section 13b, which are illustrated in FIG. 1, and a photosensitive drum, a developing section, a writing section, and a secondary transfer section, which are not illustrated. The photosensitive drum, the developing section, and the writing section each include structures corresponding to basic colors of yellow (Y), magenta (M), cyan (C), and black (K).

The fixing section 13b includes a hollow heating roller in which a heater is arranged and a pressing roller opposed to the heating roller. The rollers are controlled to a predetermined temperature (e.g., 100° C. or more) by the heater to heat and pressurize the sheets 5.

### Sheet Feed Conveyer

The sheet feed conveyer 14, illustrated in FIG. 2, includes a conveyance path 14a (see FIG. 1), a plurality of conveyance rollers and the like, and a drive motor that drives them, which are not illustrated. The sheet feed conveyer 14 rotates the respective conveyance rollers and the like at predetermined timings by the drive motor driving them and conveys sheets fed from the sheet feed device 2 to the image forming section 13.

As illustrated in FIG. 1, the conveyance path of the image forming system 100 includes the conveyance path 14a in the image forming apparatus 1, a conveyance path 33 in the image reading device 3, and a conveyance path 41 in the post-processing device 4.

The sheets 5 fed from the sheet feed device 2 are conveyed through the conveyance path 14a. Along the conveyance path 14a, a registration roller that adjusts conveyance timing of the sheets 5 by being rotated and stopped by a clutch is arranged.

A sheet 5 which has been conveyed on the conveyance path 14a and on which an image is formed by the image forming section 13 (see FIG. 2) passes through the conveyance paths 33 and 41 on the downstream side, is subjected to processing according to the print setting of the print job, and is ejected to the outside of the machine to be placed on the sheet ejection tray 42.

### Operation-and-Display Part

The operation-and-display part 15, illustrated in FIG. 2, includes, for example, a touch screen display in which a touch screen is stacked on an upper side of a liquid crystal display. The operation-and-display part 15 includes a touch screen for inputting the settings of a job to be performed by using this image forming system 100 and includes a liquid crystal display for displaying the content of the operation performed on the touch screen. The operation-and-display part 15 is disposed at an upper face of the image forming apparatus 1. Note that the operation-and-display part 15 may display the image formed by the image forming system 100 and other images.

The operation-and-display part 15 is used for input of various settings, such as printing conditions and execution timing of adjustment of formation positions of front-side and back-side images, display of a state of the apparatus, and input of various instructions.

In addition, the user is allowed to input sheet information on the sheets 5 stored in each tray of the sheet feed tray 20 through the operation-and-display part 15. The sheet information includes the type of the sheets 5 (plain paper, high-quality sheet, color sheet, coated sheet, overprint sheet (printed sheet), or the like), and the basis weight, thickness, size, and the like of the sheets 5. The inputted sheet information is stored associated with the upper tray 21, the intermediate tray 22, and the lower tray 23, or the sheet feed device 2, in the storage section 12.

The display part displays information related to the image forming system 100, information related to the states of the upper tray 21, the intermediate tray 22, and the lower tray 23 of the sheet feed device 2, information related to the states of the sheets 5 in the upper tray 21, the intermediate tray 22, and the lower tray 23, and the like. The input section includes a keyboard, a mouse, and the like.

### Communication Section

The communication section 16, according to instructions from the controller 11 of the image forming apparatus 1, reads images formed on the sheet 5 in the image forming apparatus 1 and transmits the image data obtained by reading to another image forming system 100.

As the communication section 16, various local connection interfaces such as a network interface based on a standard such as SATA, PCI Express, Universal Serial Bus (USB) (registered trademark), Ethernet (registered trademark), or IEEE1394, and a wireless communication interface such as Bluetooth (registered trademark) or IEEE802.11 are used. A print job, sent from an external terminal such as a personal computer (PC) and including print data and print settings, is received through the communication section 16

### Sheet Feed Device

As illustrated in FIG. 2, the sheet feed device 2 has the sheet feed tray 20 including the upper tray 21, intermediate tray 22, and lower tray 23, which feed the sheets 5.

Each of the upper tray 21, intermediate tray 22, and lower tray 23 of the sheet feed tray 20 is a tray in which sheets 5 are stored. In other words, the sheet feed device 2 includes a plurality of trays. Here, assume that the intermediate tray 22 is a tray that has been opened and closed immediately before.

Each of the upper tray 21, intermediate tray 22, and lower tray 23 has a lid in the respective housing, and the lid is to be opened to perform loading, replacement, or the like of the sheets 5. Opening and closing of the lids of the upper tray 21, intermediate tray 22, and lower tray 23 are detected by open/close sensors 26a, 26b, and 26c, and open/close signals each indicating whether the respective lid is opened or closed are sent to the controller 11.

The sheet feed tray 20 is, for example, a drawer type tray having three levels of the upper tray 21, intermediate tray 22, and lower tray 23 (see FIG. 1). The upper tray 21, the intermediate tray 22, and the lower tray 23 are provided respectively with attachment-detachment sensors 25a, 25b, and 25c for detecting attachment and detachment of the respective trays. The attachment/detachment states of the upper tray 21, intermediate tray 22, and lower tray 23 are respectively detected by attachment-detachment sensors 25a to 25c, and detection signals thereof are sent to the controller 11. In the upper tray 21, the intermediate tray 22, and the lower tray 23, remaining sheet quantity sensors 24a, 24b, and 24c each for measuring the remaining quantity of the sheets 5 in the respective tray are provided respectively. The remaining sheet quantity sensors 24a to 24c respectively detect the remaining quantity of the sheets in the upper tray 21, intermediate tray 22, and lower tray 23, and respectively send the detection signals indicating the results of the detections to the controller 11. The sheet feed tray 20 is not provided inside the image forming apparatus 1 but is provided in the sheet feed device 2. The sheet feed device 2 may include a multistage tray.

Note that the number of trays is not limited to three but may be four or more.

### Image Reading Device

As illustrated in FIG. 1, the image reading device 3 is a device that reads images on the front and back sides of the sheet 5 on the conveyance path 33. The image reading device 3 includes the reading section 30, the conveyance path 33, and a spectrophotometer 34 (see FIG. 2).

### Reading Section

The reading section 30 includes a scanner 31 and a scanner 32, each of which includes a CCD. The reading section 30, using the two scanners 31 and 32, reads the front and back faces of the conveyed sheet at a time. Thus, the controller 11 adjusts the image formation positions on the front and back faces.

The scanners 31 and 32 constitute the reading section 30 and are arranged on the conveyance path 33 with the conveyance path 33 in between to read images on the different sides of the sheet 5, respectively. In a case of double-sided printing, the scanner 32 reads an image on the upper face of the sheet 5, and the scanner 31 reads an image on the lower face of the sheet 5. Therefore, it is possible to read both sides of the sheet 5 subjected to double-sided printing by one time conveyance. Note that in a case of single-sided printing, the image on the front side of the sheet 5 is read by the scanner 32 alone.

The controller 11 analyzes image data obtained via the scanners 31 and 32 to automatically performing adjustments such as a position adjustment of the sheet 5, a color adjustment, and an image position adjustment. Each of the scanners 31 and 32 (see FIG. 1) is provided with a back roller (not illustrated) at a position opposite thereto with the conveyance path 33 in between. The scanners 31 and 32 have the same configuration.

The reading section 30 is a device that reads images formed on a sheet 5.

Each of the scanners 31 and 32 includes a line image sensor, a lens optical system, a Light Emitting Diode (LED) light source, a housing that houses these components, and the like, and reads an image printed on the sheet 5 being conveyed. When reading the image, light from a LED light source irradiates a face of the sheet 5 passing through a reading position on the conveyance path 33. An image at this reading positions is guided by a lens optical system and formed on a line image sensor to be read.

The spectrophotometer 34 shown in FIG. 2 spectroscopically measures, between the spectrophotometer 34 and a counterpart member (not illustrated) disposed with the conveyance path 33 (see FIG. 1) interposed therebetween, the color of each color patch of the color evaluation image formed on the sheet 5 by the image forming section 13 and acquires the spectral reflectance of the wavelengths in the visible light region and the regions near the visible light region. The colorimetric data can be output, for example, in a color system such as XYZ.

### Post-Processing Device

The post-processing device 4 (see FIG. 1) is a device for detecting whether there is dirt on the sheet 5 ejected from the image reading device 3 and detecting whether there is dirt on the printed sheet 5. The post-processing device 4 includes the conveyance path 41, the sheet ejection tray 42, and a post-processor 43 (see FIG. 2). As illustrated in FIG. 2, the post-processing device 4 is connected to the sheet feed device 2 and the communication section 16 of the image forming apparatus 1 via a network, a dedicated line, or the like.

The post-processor 43 of the post-processing device 4 is provided in the conveyance path 41. The post-processor 43 may include a stack section and a staple section. A plurality of sheets 5 is stacked by the stack section and then side-stitched by the staple section using staples. As shown in FIG. 1, the bundle of the side-stitched sheets 5 is ejected onto the sheet ejection tray 42. The sheets 5 not side-stitched are ejected as they are via the conveyance path 41.

### Process of Front-to-Back Registration Adjustment Method

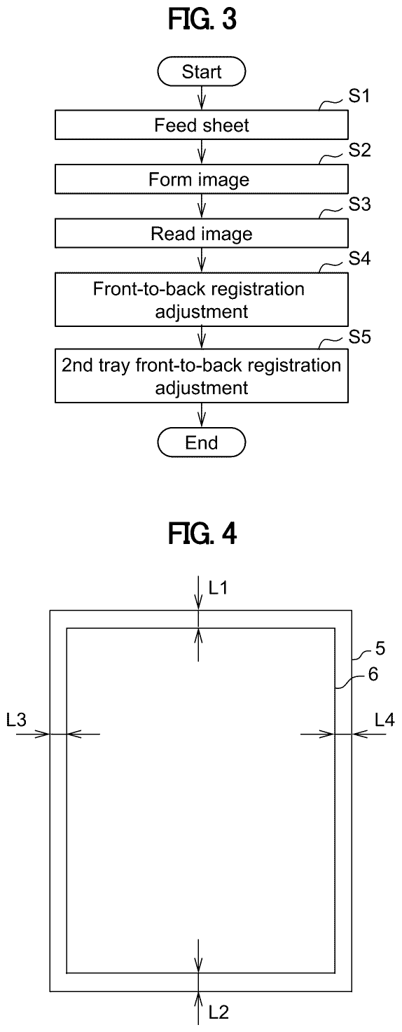

FIG. 3 is a process diagram illustrating a front-to-back registration adjustment method according to an embodiment of the present invention.

As illustrated in FIG. 3, the front-to-back registration adjustment method includes a sheet feeding step S1, an image forming step S2, a reading step S3, an image front-to-back registration adjustment step S4, and a second tray front-to-back registration adjustment step S5.

As illustrated in FIG. 1 or 3, in the front-to-back registration adjustment method of the present invention, in the sheet feeding step S1, a user supplies sheets 5 to the upper tray 21 and the intermediate tray 22.

In the image forming step S2, the image forming apparatus 1 forms images on a fed sheet 5 by the image forming section 13.

In the reading step S3, the image forming apparatus 1 reads the images formed on the sheet 5 by the reading section 30.

In the image front-to-back registration adjustment step S4, the image forming apparatus 1 performs a front-to-back image registration adjustment based on the result read by the reading section 30.

In the second tray front-to-back registration adjustment step S5, when performing image formation on sheets 5 fed from the upper tray 21 and subsequently performing image formation on sheets 5 fed from intermediate tray 22, the image forming apparatus 1, in the middle of the image formation on the sheets 5 fed from the upper tray 21, form an image on a sheet 5 fed from the intermediate tray 22 and read the formed image to perform a front-to-back registration adjustment of the images to be formed on the sheets 5 fed from the intermediate tray 22.

### Front-to-Back Image Registration Adjustment

FIG. 4 is an explanatory diagram illustrating a front-to-back image registration adjustment chart.

A front-to-back registration adjustment for a tray can be performed by printing the front-to-back registration adjustment chart illustrated in FIG. 4, reading it with the scanners 31 and 32 (see FIGS. 1 and 2), and analyzing the read image by the controller 11.

The controller 11 (see FIG. 2) detects, using the front-side and back-side scanners 31 and 32 (see FIGS. 1 and 2), how far the distances L1, L2, L3, and L4 from the upper, lower, left, and right outer peripheral ends of the sheet 5 to the line drawing 6 of the inner image are from the ideal positions. The controller 11, illustrated in FIG. 2, analyzes the detection data detected by the scanners 31 and 32 and automatically adjusts the position, magnification, inclination, and the like of the sheet 5.

### Periodic Front-to-Back Image Registration Adjustment

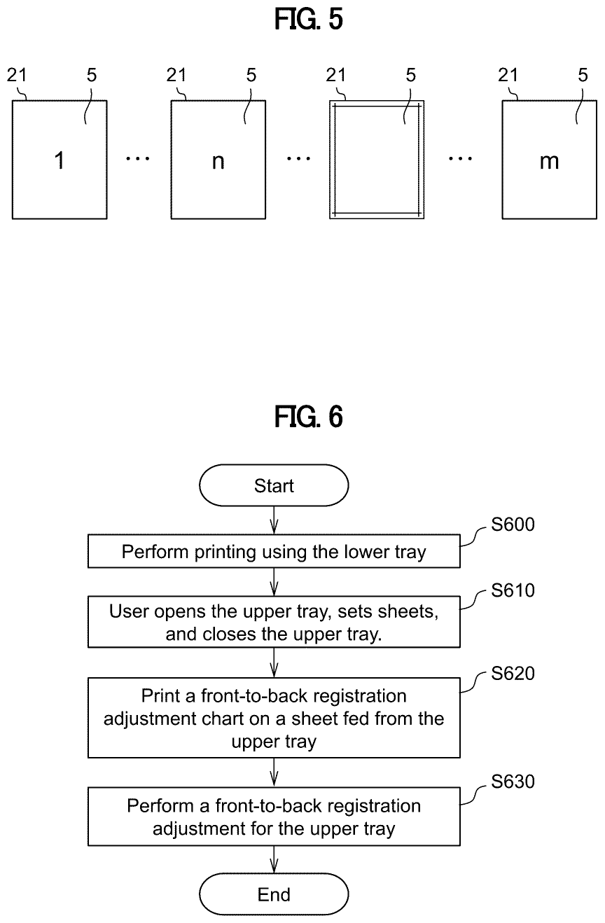

FIG. 5 is an explanatory diagram for explaining a periodic front-to-back image registration adjustment.

When the image forming apparatus 1 executes a print job while feeding sheets from the same tray and has printed a specified number of sheets, the image forming apparatus 1 performs interrupt printing of a front-to-back registration adjustment chart on a sheet 5 and performs front-to-back registration adjustment using the front-to-back registration adjustment chart printed on the sheet 5. Regarding the periodic front-to-back registration adjustment according to the present invention, although the image forming apparatus 1 of the present invention performs interrupt printing of the front-to-back registration adjustment chart during execution of a print job, as the image forming apparatus 1 outputs without stopping feeding of the sheets for the print job, the productivity of the print job is not reduced.

The image forming apparatus 1 applies the result of the periodic front-to-back image registration adjustment after printing a certain number of sheets subsequent to the printing of the front-to-back registration adjustment chart. The result of the adjustment obtained by the analysis by the image forming apparatus 1 in the periodic front-to-back image registration adjustment is used to determine adjustment values, which are applied after printing a certain number of sheets subsequent to the outputting the front-to-back registration adjustment chart, thereby to maintain the productivity.

### Example of Printing in Which Front-to-Back Registration Adjustment is Performed Without Reducing Productivity

In FIG. 5, it is conceivable that the upper tray 21 is loaded with sheets 5 while printing using the lower tray 23. When the upper tray 21 is opened, the sheets are set in the upper tray 21, and the upper tray 21 is closed, supplying the sheet 5 to the upper tray 21 is completed. In this case, after the completion of supplying the sheets 5 to the upper tray 21, a front-to-back registration adjustment of the images to be formed on the sheets 5 fed from the upper tray 21 is performed. In this way, it is possible to shorten the time required for the front-to-back registration adjustment of the images to be formed on the sheet 5 fed from the upper tray 21.

Even when the tray from which sheets are to be fed is not switched from the lower tray 23 to the upper tray 21 during the current print job, the front-to-back registration adjustment for the images to be printed on the sheets 5 fed from the upper tray 21 has been completed. Therefore, when the image forming apparatus 1 uses the upper tray 21 for the next print job, there is no need of performing a front-to-back image registration adjustment.

FIG. 6 is a process diagram illustrating a periodic front-to-back image registration adjustment, and shows an example of printing process in which the front-to-back image registration adjustment is performed without reducing productivity.

As illustrated in FIG. 6, first, the image forming apparatus 1 performs (step S600) a print job using the lower tray 23. Here, assume that while printing on the sheets 5 from the m-th page using the lower tray 23, the user opens the upper tray 21, sets the sheets 5 to the upper tray 21, and then closes the upper tray 21 (step S610). Here, the image forming apparatus 1, in an interruption to the print job of the sheet 5 using the lower tray 23, prints (step S620) a front-to-back registration adjustment chart on a sheet 5 fed from the upper tray 21 and performs (step S630) a front-to-back registration adjustment for the upper tray 21. In this way, the image forming apparatus 1 can perform the front-to-back image registration adjustment without reducing productivity.

The image forming apparatus 1 determines the front-to-back registration adjustment values after printing several sheets subsequent to printing the front-to-back registration adjustment chart. This is because the front-to-back registration adjustment values are determined after the front-to-back registration adjustment chart is read by the scanners 31 and 32 and then analyzed by the controller 11. However, as this determination is completed before performing a print job using the sheets in the upper tray 21, there is no influence on that print job. Optional Execution of Periodic Front-to-Back Image Registration Adjustment

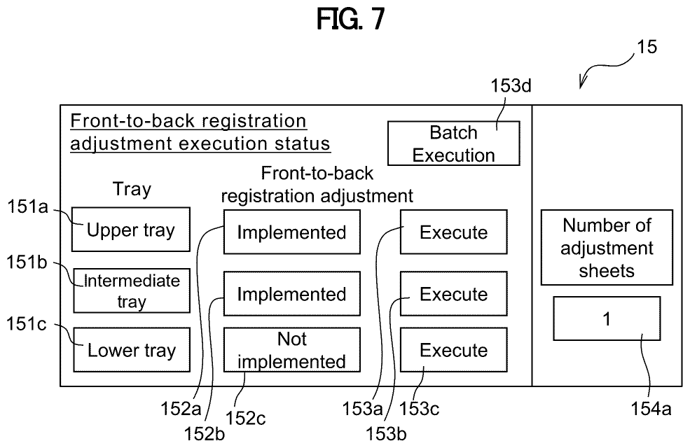

FIG. 7 is a schematic diagram illustrating an example of a screen of the operation-and-display part 15 of the image forming system 100 according to the embodiment of the present disclosure.

In a modification example of the present disclosure, after the user sets sheets 5 to any tray of the sheet feed tray 20, the image forming apparatus 1 may optionally perform a periodic front-to-back registration adjustment for a tray selected by the user while printing.

As illustrated in FIG. 7, the operation-and-display part 15 presents a state of front-to-back registration adjustment for each tray. The text box 151a displays “Upper tray” indicating the upper tray 21. The text box 151b displays “Intermediate tray” indicating the intermediate tray 22. The text box 151c displays “Lower tray” indicating the lower tray 23.

As the front-to-back registration adjustment state 152a, whether a front-to-back registration adjustment has been performed or has not been performed for the upper tray 21 after the upper tray 21 is opened and then closed is displayed as “Implemented” or “Not implemented”.

As the front-to-back registration adjustment state 152b, whether a front-to-back registration adjustment has been performed or has not been performed for the intermediate tray 22 after the intermediate tray 22 is opened and then closed is displayed as “Implemented” or “Not implemented”.

As the front-to-back registration adjustment state 152c, whether a front-to-back registration adjustment has been performed or has not been performed for the lower tray 23 after the lower tray 23 is opened and then closed is displayed as “Implemented” or “Not implemented”.

When the user wants to execute a periodic front-to-back image registration adjustment for a desired tray, the user taps the execution button 153a, 153b, or 153c corresponding to the desired tray. The execution button 153a is a button for executing a periodic front-to-back registration adjustment for the upper tray 21. The execution button 153b is a button for executing a periodic front-to-back registration adjustment for the intermediate tray 22. The execution button 153c is a button for executing a periodic front-to-back registration adjustment for the lower tray 23.

The user is allowed, by tapping any of the execution buttons 153a to 153c, to execute a periodic front-to-back registration adjustment for the tray corresponding to the tapped button during a print job.

When the user wants to perform a front-to-back registration adjustment for any tray of the upper tray 21, intermediate tray 22, and lower tray 23, for which tray the front-to-back registration adjustment has not been performed after the tray is opened and then closed, the user may tap the batch execution button 153d. By tapping the batch execution button 153d, a front-to-back registration adjustment is collectively executed for all the trays for which the front-to-back registration adjustment has not been executed.

In a case, for example, where the adjustment through a front-to-back registration adjustment using the front-to-back registration adjustment chart formed on only one sheet 5 is not sufficient, the image forming apparatus 1 may use mean values of the front-to-back registration adjustment charts formed on a plurality of sheets 5, to ensure the accuracy of the front-to-back registration adjustment. To this end, the user is allowed to specify in the input field 154a the number of the plurality of sheets 5 on each of which the front-to-back registration adjustment chart is to be formed, and the image forming apparatus 1 outputs the specified number of sheets 5 from a specified tray to perform a periodic front-to-back image registration adjustment using the mean values of the front-to-back registration adjustment charts formed on the sheets 5.

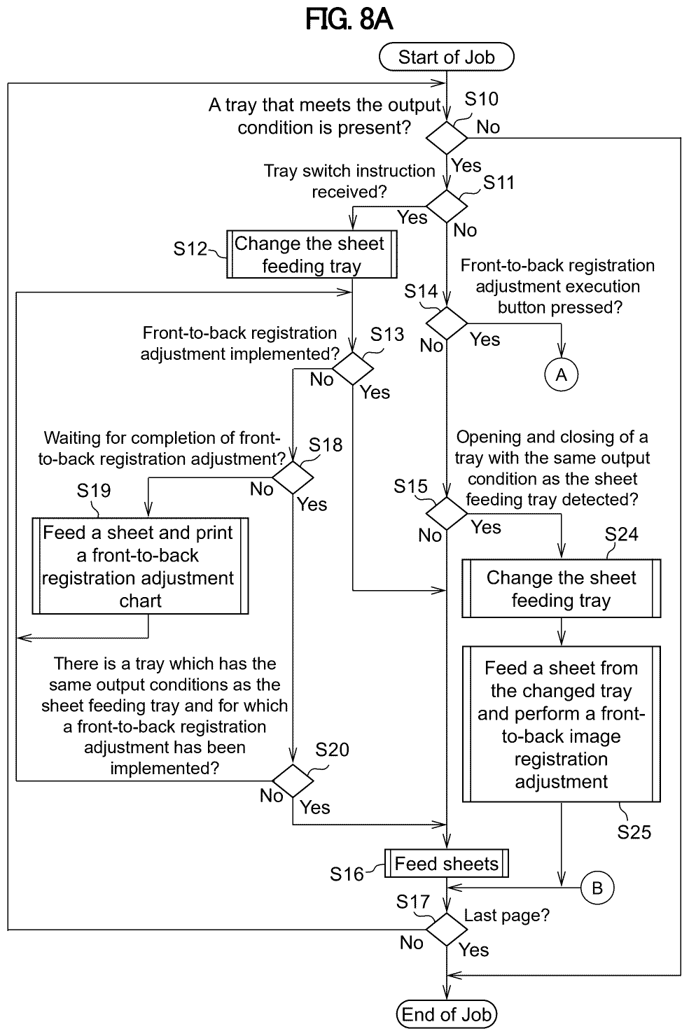

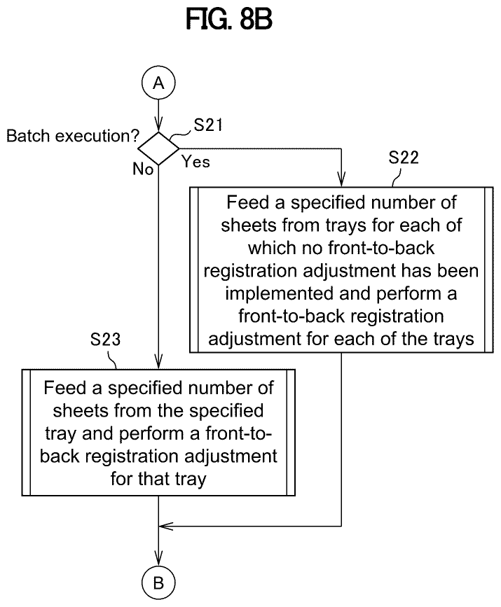

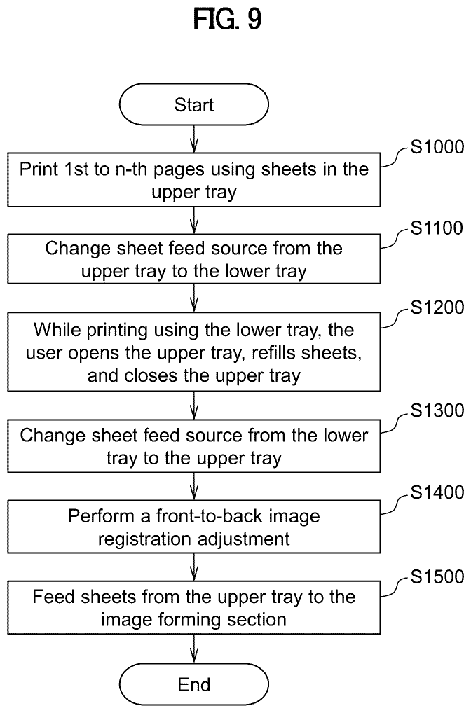

FIGS. 8A and 8B are a flowchart illustrating a front-to-back registration adjustment method according to the embodiment of the present invention.

Next, with reference mainly to FIGS. 8A and 8B and with reference to FIGS. 1 and 2, description will be given of the front-to-back registration adjustment method.

First, the controller 11 of the image forming system 100 starts job output. The controller 11 determines (step S10) whether there is a tray in the sheet feed tray 20 that meets the output condition. When there is no tray meeting the output condition (No in step S10), the controller 11 ends the job. When there is a tray meeting the output condition (Yes in step S10), the controller 11 determines (step S11) whether an instruction to switch the tray has been made.

When a tray switching instruction has been made (Yes in step S11), the controller 11 switches (step S12) the sheet feed source to a tray meeting the output condition. The controller 11 checks whether a front-to-back registration adjustment for the switched tray has been implemented (step S13). In a case where the front-to-back registration adjustment has been implemented (Yes in step S13), the controller 11 feeds (step S16) sheets 5 from the switched tray to execute the print job and determines (step S17) whether printing has been performed up to the last page.

When printing has been performed up to the last page of the print job (Yes in step S17), the controller 11 finishes the job. Then, when the printing has not been performed up to the last page of the print job (No in step S17), the process returns to step S10.

When the front-to-back registration adjustment has not been completed in step S13 (no in step S13), the controller 11 determines (step S18) whether the controller 11 is in a state of waiting for completion of a front-to-back image registration adjustment. When the controller 11 is not in a state of waiting for the completion of the front-to-back image registration adjustment (No in step S18), the controller 11 feeds a sheet 5 to the image forming section 13 and causes the image forming section 13 to print the front-to-back registration adjustment chart (step S19), and returns to step S13.

When the controller 11 is in a state of waiting for the completion of the front-to-back image registration adjustment (Yes in step S18), the controller 11 determines (step S20) whether there is a tray which has the same output conditions as the tray currently feeding sheets and for which a front-to-back registration adjustment has been implemented. When there is a tray for which a front-to-back registration adjustment has been implemented (Yes in step S20), the controller 11 feeds (step S16) sheets 5 from that tray to the image forming section 13, and when printing has been performed up to the last page (Yes in step S17), finishes the job.

In step S11, when a tray switching instruction has not been made (No in step S11), the controller 11 determines whether any one of the execution buttons 153a to 153c and batch execution button 153d for front-to-back registration adjustment has been tapped. If any one of the execution buttons 153a to 153c and batch execution button 153d for front-to-back registration adjustment has been tapped (YES in step S14), the controller 11 further determines (step S21) whether the batch execution button 153d has been tapped. When the batch execution button 153d has been tapped (Yes in step S21), the processing proceeds to step S22. Then, the controller 11 feeds a specified number of sheets 5 from each of a tray(s) for which no front-to-back registration adjustment has been implemented and performs (step S22) a front-to-back registration adjustment for each of the tray(s). Then, the process proceeds to step S17 to determine (step S17) whether printing has been performed up to the last page of the print job.

In step S21, when any one of the execution buttons 153a to 153c for front-to-back registration adjustment, rather than the batch execution button 153d, has been tapped (No in step S21), the controller 11 feeds a specified number of sheets 5 from the tray specified by tapping and performs (step S23) a front-to-back registration adjustment for that tray. Then, the process proceeds to step S17 to determine (step S17) whether printing has been performed up to the last page of the print job.

In step S14, when none of the execution buttons 153a to 153c and batch execution button 153d for front-to-back registration adjustment has been tapped (No in step S14), the process proceeds to step S15. Then, the controller 11 determines (step S15) whether there has been a detection of a tray having the same output condition as that of the tray currently feeding sheets and having been opened and then closed. When there has been no detection of a tray having the same output condition as that of the tray currently feeding sheets and having been opened and then closed (No in step S15), the process proceeds to step S16.

In step S15, when there has been a detection of a tray having the same output condition as that of the tray currently feeding sheets and having been opened and then closed (Yes in step S15), the controller 11 changes (step S24) the tray from which the sheets are to be fed. Then, the controller 11 feeds a sheet 5 from the changed tray and performs a front-to-back image registration adjustment (step S25) and the process proceeds to step S17. Then, the controller 11 determines (step S17) whether printing has been performed up to the last page.

When printing has been performed up to the last page of the print job (Yes in step S17), the controller 11 finishes the print job. Then, when the printing has not been performed up to the last page of the print job (No in step S17), the controller 11 returns to step S10.

As illustrated in FIG. 1 or 2, an image forming apparatus 1 of the present invention is included in an image forming system 100 including: a first tray (upper tray 21, intermediate tray 22, or lower tray 23) that feeds recording media (sheets 5); a second tray (upper tray 21, intermediate tray 22, or lower tray 23) that feeds recording media (sheets 5); and a reading section 30. The image forming apparatus 1 includes: a controller 11; and an image forming section 13 that forms images on the recording media fed from the first tray and the recording media fed from the second tray. The reading section 30 is configured to read the images formed on the recording media fed from the first tray and the recording media fed from the second tray. The controller 11, while performing a print job on the recording media fed from the first tray: prints, using the image forming section 13, a front-to-back registration adjustment chart on a recording medium fed from the second tray; reads the printed front-to-back registration adjustment chart using the reading section 30; and performs a front-to-back registration adjustment for the second tray based on the read front-to-back registration adjustment chart.

According to this configuration, the image forming apparatus 1 of the present invention is capable of preventing the occurrence of waste sheets due to misalignment of images on the front and back sides. Furthermore, according to the present invention, for example, the controller 11 performs the front-to-back image registration adjustment for the intermediate tray 22 while performing the print job on the sheets 5 fed from the upper tray 21. Therefore, the print job being performed using the sheet 5 fed from the upper tray 21 is not stopped due to the front-to-back registration adjustment for the intermediate tray 22, thus allowing efficient printing without reducing productivity.

Furthermore, the controller 11, while performing a print job on the recording media fed from the first tray, when the second tray has been opened and then closed: prints the front-to-back registration adjustment chart on the recording medium fed from the second tray; reads the printed front-to-back registration adjustment chart using the reading section 30; and performs the front-to-back registration adjustment for the second tray based on the read front-to-back registration adjustment chart.

According to such a configuration, the controller 11 is capable of, for example with a detection of opening and closing of the intermediate tray 22 as a trigger, performing the front-to-back registration adjustment for the intermediate tray 22.

The controller 11 forms, using the image forming section 13, a front-to-back registration adjustment chart on a recording medium (sheet 5).

According to such a configuration, the image forming section 13 forms the front-to-back registration adjustment chart on the sheet 5 to perform the front-to-back image registration adjustment on the sheet 5, thereby to adjust the positions of the front-side and back-side images appropriately.

The image forming section 13 illustrated in FIGS. 1 and 2 forms images on recording media (sheets 5) fed from the second tray (upper tray 21, intermediate tray 22, and lower tray 23) for which the front-to-back registration adjustment has been performed.

According to such a configuration, the image forming section 13 forms images on the sheet 5 fed from the intermediate tray 22 for which the front-to-back registration adjustment has been performed, so that the image forming section 13 is capable of forming the images on the front and back sides of the desired sheet 5 without deviations from the desired positions on the sheet 5.

There are a plurality of second trays (upper tray 21, intermediate tray 22, and lower tray 23) shown in FIG. 1.

Such a configuration is convenient because providing a plurality of second trays makes it possible to store sheets 5 with different sizes and various types of sheets 5 in the second trays, thereby enabling use of even more types of sheets 5.

When a predetermined condition is satisfied, the controller 11 illustrated in FIG. 2 may, while performing image formation using the recording media (sheets 5) fed from the first tray (upper tray 21), perform the front-to-back registration adjustment of the images to be formed on the recording medium (sheet 5) fed from the second tray (intermediate tray 22).

Here, examples of the predetermined condition include a condition that, when the second tray is opened, new recording media are refilled, and then the second tray is closed, the type and/or the size of the newly set recording media is the same as that of the recording media set in the first tray.

According to such a configuration, the controller 11 controls to perform the front-to-back registration adjustment of the images to be formed on the sheets 5 to be fed from the intermediate tray 22 while performing image formation on the sheets 5 stored in the upper tray 21. As a result, the controller 11 is capable of efficiently performing the front-to-back registration adjustment of the images to be formed on the sheet 5 to be fed from the intermediate tray 22.

When the first tray (upper tray 21) runs out of recording media (sheets 5) before the front-to-back registration adjustment for the second tray (intermediate tray 22) is completed, the controller 11 shown in FIG. 2 may switch the feed source (sheet feed source) of the sheets 5 to another tray which has the same condition as the upper tray 21 and for which a front-to-back image registration adjustment has been completed.

According to such a configuration, even if the upper tray 21 runs out of sheets before the front-to-back registration adjustment for the intermediate tray 22 is completed, the controller 11 can promptly continue the print job by switching the sheet feed source to another tray.

As shown in FIG. 2, an image forming system 100 according to the present invention includes: a first tray (upper tray 21) that feeds recording media (sheets 5); a second tray (intermediate tray 22) that feeds recording media (sheets 5); an image forming section 13 that forms images on the recording media fed from the first tray and the recording media fed from the second tray; a reading section 30 that reads the images formed on the recording media fed from the first tray and the recording media fed from the second tray, and a controller 11 that, while performing a print job on the recording media fed from the first tray: prints, using the image forming section 13, a front-to-back registration adjustment chart on a recording medium fed from the second tray; reads the printed front-to-back registration adjustment chart using the reading section 30; and performs a front-to-back registration adjustment for the second tray based on the read front-to-back registration adjustment chart.

According to such a configuration, the image forming system 100 is capable of preventing the occurrence of waste sheets due to misalignment of images on the front and back sides.

Further, the controller 11 according to the present invention performs the front-to-back image registration adjustment for the intermediate tray 22 while performing the print job on the sheet 5 fed from the upper tray 21. Therefore, the print job being performed on the sheets 5 fed from the upper tray 21 is not stopped due to the front-to-back registration adjustment for the intermediate tray 22, thus allowing efficient printing without reducing productivity.

As has been described, a front-to-back registration adjustment method according to the present invention includes steps of, by a controller 11: while performing a print job on recording media (sheets 5) fed from a first tray (upper tray 21), printing a front-to-back registration adjustment chart on a sheet 5 fed from an intermediate tray 22 using an image forming section 13; reading the printed front-to-back registration adjustment chart using a reading section 30; and performing a front-to-back registration adjustment for the intermediate tray 22 based on the read front-to-back registration adjustment chart.

According to such a configuration, by performing the front-to-back registration adjustment method of the present invention, it is possible to prevent the occurrence of waste sheets due to misalignment of the images on the front and back sides.

Furthermore, according to the present invention, the front-to-back image registration adjustment is performed for the intermediate tray 22 during the print job being performed on the sheets 5 fed from the upper tray 21. Therefore, the print job being performed using the sheet 5 fed from the upper tray 21 is not stopped due to the front-to-back registration adjustment for the intermediate tray 22, thus allowing efficient printing without reducing productivity.

As illustrated in FIG. 2, a program 12a according to the present invention causes a computer 11a to execute steps including: while performing a print job on recording media (sheets 5) fed from a first tray (upper tray 21), printing, using an image forming section 13, a front-to-back registration adjustment chart on a sheet 5 fed from a second tray (intermediate tray 22); reading the printed front-to-back registration adjustment chart using a reading section 30; and performing a front-to-back registration adjustment for the intermediate tray 22 based on the read front-to-back registration adjustment chart.

According to such a configuration, the program 12a according to the present invention causes the controller 11 to, using the image forming section 13, print the front-to-back registration adjustment chart on the sheet 5 fed from the intermediate tray 22, read the front-to-back registration adjustment chart using the reading section 30, and perform the front-to-back registration adjustment for the intermediate tray 22.

According to such a configuration, by executing the program of the present invention, it is possible to prevent the occurrence of waste sheets due to misalignment of images on the front and back sides.

Furthermore, according to the present invention, the front-to-back image registration adjustment is performed for the intermediate tray 22 during the print job being performed on the sheets 5 fed from the upper tray 21. Therefore, the print job being performed using the sheet 5 fed from the upper tray 21 is not stopped due to the front-to-back registration adjustment for the intermediate tray 22, thus allowing efficient printing without reducing productivity.

### Modification Example

Although the embodiments of the present invention have been described above, the present invention is not limited to the above-described embodiments and can be appropriately modified without departing from the gist of the present invention.

For example, the case where the sheet feed tray 20 is included in the sheet feed device 2 has been described, but the sheet feed tray 20 may be included in the image forming apparatus 1.

Although embodiments of the present invention and modifications of the embodiments have been described and illustrated in detail, the disclosed embodiments and modifications are made for purposes of illustration and example only and not limitation. The scope of the present invention should be interpreted by the terms of the appended claims.

1. An image forming apparatus in an image forming system including: a first tray that feeds recording media; a second tray that feeds recording media; and a reading section, the image forming apparatus comprising:
a controller; and
an image forming section that forms images on the recording media fed from the first tray and the recording media fed from the second tray,
wherein the reading section is configured to read the images formed on the recording media fed from the first tray and the recording media fed from the second tray, and
wherein the controller, while performing a print job on the recording media fed from the first tray:
prints, using the image forming section, a front-to-back registration adjustment chart on a recording medium fed from the second tray;
reads the printed front-to-back registration adjustment chart using the reading section; and
performs a front-to-back registration adjustment for the second tray based on the read front-to-back registration adjustment chart.

2. The image forming apparatus according to claim 1,
wherein the controller, while performing the print job on the recording media fed from the first tray, when the second tray has been opened and then closed:
prints, using the image forming section, the front-to-back registration adjustment chart on the recording medium fed from the second tray;
reads the printed front-to-back registration adjustment chart using the reading section; and
performs the front-to-back registration adjustment for the second tray based on the read front-to-back registration adjustment chart.

3. The image forming apparatus according to claim 1,
wherein the controller forms a front-to-back registration adjustment chart on a recording medium using the image forming section.

4. The image forming apparatus according to claim 1,
wherein the controller, using the image forming section, forms images on recording media fed from the second tray for which the front-to-back registration adjustment has been performed.

5. The image forming apparatus according to claim 1,
wherein the second tray is provided in plurality.

6. The image forming apparatus according to claim 1,
wherein when a predetermined condition is satisfied, the controller, while performing image formation using the recording media fed from the first tray, performs a front-to-back registration adjustment of images to be formed on the recording media fed from the second tray.

7. The image forming apparatus according to claim 1,
wherein when the first tray runs out of recording media before the front-to-back registration adjustment for the second tray is completed, the controller switches a feed source of recording media to another tray which has a same condition as the first tray and for which a front-to-back image registration adjustment has been completed.

8. An image forming system comprising:
a first tray that feeds recording media;
a second tray that feeds recording media;
an image forming section that forms images on the recording media fed from the first tray and the recording media fed from the second tray;
a reading section that reads the images formed on the recording media fed from the first tray and the recording media fed from the second tray, and
a controller that, while performing a print job on the recording media fed from the first tray:
prints, using the image forming section, a front-to-back registration adjustment chart on a recording medium fed from the second tray;
reads the printed front-to-back registration adjustment chart using the reading section; and
performs a front-to-back registration adjustment for the second tray based on the read front-to-back registration adjustment chart.

9. A front-to-back registration adjustment method comprising steps of, by a controller, while performing a print job on recording media fed from a first tray:
printing, using an image forming section, a front-to-back registration adjustment chart on a recording medium fed from a second tray;
reading the printed front-to-back registration adjustment chart using a reading section; and
performing a front-to-back registration adjustment for the second tray based on the read front-to-back registration adjustment chart.

10. A non-transitory computer-readable storage medium storing a computer program for causing a computer to execute steps comprising, while performing a print job on recording media fed from a first tray:
printing, using an image forming section, a front-to-back registration adjustment chart on a recording medium fed from a second tray;
reading the printed front-to-back registration adjustment chart using a reading section; and
performing a front-to-back registration adjustment for the second tray based on the read front-to-back registration adjustment chart.
